(19) United States
(12) Patent Application Publication
(10) Pub. No.: US 2022/0180460 A1
(43) Pub. Date: Jun. 9, 2022

(54) RENTAL SPACE

(71) Applicant: TAISHO SKY BUILDING, INC., Tokyo (JP)

(72) Inventor: Kazuharu ISHIDA, Tokyo (JP)

(21) Appl. No.: 17/651,937

(22) Filed: Feb. 22, 2022

Related U.S. Application Data
(63) Continuation of application No. PCT/JP2019/032781, filed on Aug. 22, 2019.

(51) Int. Cl. G06Q 50/16; G06Q 10/02; G06Q 30/06; G06Q 10/00

(52) U.S. Cl. CPC G06Q 50/16; G06Q 10/20; G06Q 30/0645; G06Q 10/02

(57) ABSTRACT

A rental space includes a management server, maintenance devices for performing maintenance of a room, and a device that is a detection unit for detecting the presence or absence of a moving body inside the room. The management server includes: a reservation manager that manages reservation information of the room; a device manager that manages the devices; a spare time obtainer that obtains spare time of the room; a state determiner that determines whether the room is in spare time and is in a non-use state with no moving body in the room; and a management mode switcher that switches a management mode from a normal mode to a maintenance mode in which the devices to perform maintenance of the room, when the room is in the non-use state.

### RELATED APPLICATIONS

The present application is a continuation of International Patent Application No. PCT/JP2019/032781, filed Aug. 22, 2019, which is hereby incorporated by reference in its entirety.

### TECHNICAL FIELD

This disclosure relates to a rental space in which a usage time is set and the space is rented to a user.

### BACKGROUND

A system for renting an empty room of a building (e.g., an office, a hotel, or the like) to users typically includes a management server open to a communication network such as the Internet, and a plurality of reservation servers in which information on the conference room is stored. Such a system is typically configured so that users can access information describing the conference room in a reservation server via the management server and reserve a desired conference room. Such a system also typically has a billing function so that a rental fee can be paid online.

However, although the user can make a reservation and pay in advance via a communication network, management of the space in spare time when the space is not used is not assumed. Therefore, in order to perform maintenance of the space such as cleaning and ventilation, it is necessary for an administrator to perform maintenance after grasping the spare time of the space, and thus there is a problem that manpower is required, resulting in an increase in operating cost.

### SUMMARY

An object of the present disclosure is to provide a reservation system (also referred to as a rental facility or a rental space) capable of suppressing operation costs by efficiently performing maintenance in spare time when the space is not used.

The rental space of the present disclosure is a rental space in which a usage time is set and a space is rented to a user, including: a management server that manages the rental space; a maintenance device that performs maintenance of the space; and a detection unit that detects the presence or absence of a moving body in the space, in which the management server includes: a reservation manager that manages reservation information on a reservation date and time of the user who use the space; a device manager that manages information on the maintenance device and the detection unit; a spare time obtainer that obtains spare time of the space on the basis of the reservation information; a state determiner that determines whether the space is in spare time and is in a non-use state with no moving body in the space on the basis of a detection result of the detection unit and an obtained result of the spare time obtainer; and a management mode switcher that switches a management mode from a normal mode to a maintenance mode in which the maintenance device performs maintenance of the space, when the state determiner determines that the space is in the non-use state.

According to the present disclosure as described above, the rental space includes: the management server; the maintenance device; and the detection unit, and the management server includes: the reservation manager that manages the reservation information; the device manager that manages the information on the maintenance device and the detection unit; the spare time obtainer that obtains the spare time of the space; the state determiner that determines whether the space is in the non-use state with no moving body in the space; and the management mode switcher that switches the management mode from the normal mode to the maintenance mode, so that the maintenance can be performed in the rental space before a reservation date and time of a next user. Therefore, since the maintenance device can be made to perform maintenance by efficiently utilizing the spare time of the space, it is possible to reduce manual management by the administrator or the like, thereby suppressing the operation costs.

At this time, in the present disclosure, it is preferred that the device manager manages a time required to perform maintenance by the maintenance device, the management server includes a maintenance determiner that determines whether the maintenance can be performed on the basis of the spare time obtained by the spare time obtainer and the time required to perform maintenance by the maintenance device, when the management mode switcher switches the management mode to the maintenance mode, and when the maintenance determiner determines that the maintenance can be performed, the device manager causes the maintenance device to perform maintenance.

With such a configuration, the management server includes the maintenance determiner that determines whether the maintenance can be performed on the basis of the spare time and the time required to perform maintenance by the maintenance device, when the management mode is switched to the maintenance mode, and when the maintenance determiner determines that the maintenance can be performed, the device manager causes the maintenance device to perform maintenance, so that the maintenance can be completed in the rental space before the reservation date and time of the next user.

Further, in the present disclosure, it is preferred that the management server includes a security mode switcher that switches a security mode from a normal mode to a secure mode for guarding the space, when the state determiner determines that the space is in the non-use state.

With such a configuration, the management server includes the security mode switcher that switches the security mode from the normal mode to the secure mode when the state determiner determines that the space is in the non-use state, so the space can be guarded in spare time of the space and before the reservation date and time of the next user, in the rental space.

At this time, in the present disclosure, it is preferred that the management server includes: an abnormality detector that detects an abnormality in the space on the basis of the detection result of the detection means, in the secure mode; and an abnormality notifier that notifies an administrator of the rental space of the abnormality in the space when the abnormality detector detects the abnormality in the space.

With such a configuration, the management server includes the abnormality notifier that notifies the administrator of the rental space of the abnormality in the space when the abnormality detector detects the abnormality in the space, so that the administrator of the rental space can recognize the abnormality in the space.

Further, in the present disclosure, it is preferred that the abnormality detector does not detect an operation of the maintenance device as the abnormality in the space.

With such a configuration, since the abnormality detector does not detect the operation of the maintenance device as the abnormality in the space, the management server can cause the maintenance device to perform maintenance even in the secure mode.

Further, in the present disclosure, it is preferred that the management server includes a command transmitter that transmits a command for guarding the space to an external security system via a communication line, in the secure mode.

With such a configuration, the management server includes the command transmitter that transmits the command for guarding the space to the external security system via the communication line, in the secure mode, so that the rental space does not have to include a device for guarding the space, and it is possible to simplify a configuration of the rental space, thereby further suppressing the operation costs.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a schematic configuration diagram of a rental space in accordance with some implementations.

FIG. 2 is a block diagram illustrating a configuration of a management server in the rental space in accordance with some implementations.

FIG. 3 is a flowchart illustrating an operation of a management mode by the management server in accordance with some implementations.

FIG. 4 is a flowchart illustrating an operation of a security mode by the management server in accordance with some implementations.

### DETAILED DESCRIPTION

Hereinafter, implementations of the present disclosure will be described with reference to the drawings.

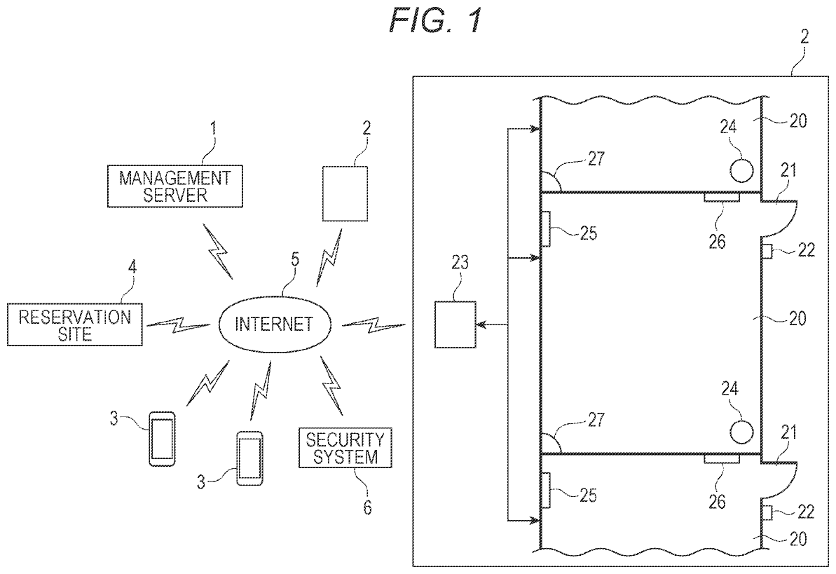

FIG. 1 is a schematic configuration diagram of a rental space in accordance with some implementations.

As illustrated in FIG. 1, the rental space includes a management server 1 for managing the rental space, and there is a plurality of buildings 2 having a plurality of rooms 20 which is a space for renting to users. The host 1, the buildings 2, terminal devices 3 such as a mobile phone, a smart phone, and a personal computer owned by the user, and a reservation site 4 for reserving a rental of the room 20 can be connected to each other via the Internet 5 which is a public network as a communication line. The user can access the reservation site 4 via the Internet 5 using the terminal device 3, search for the room 20 according to a purpose, and specify a usage time, to perform a reservation. When the reservation site 4 receives the reservation from the user, the reservation site 4 transmits reservation information including the room 20 for which the reservation has been established and a reservation time to the management server 1. Further, the management server 1 and the building 2 are connected to an external security system 6 via the Internet 5.

The building 2 includes the rooms 20 such as a conference room and a training room, and each room 20 is provided with a doorway 21 and a locking device 22 for locking and unlocking the doorway 21. The locking device 22 can be unlocked by an authentication key such as a password or a bar code issued from the reservation site 4 to the terminal device 3 of the user, and the authentication key is randomly changed each time it is used, so that only the user who made a reservation at that time can unlock the locking device 22 by using a unique authentication key. A communication terminal device 23 such as a modem or a router is connected to each room 20 via a local area network (LAN), and devices 24 to 27 provided inside each room 20 is connected to the Internet 5 via the communication terminal device 23. Note that in the present implementations, the password, the bar code, or the like is employed as the authentication key, however, for example, biometric authentication such as face authentication, fingerprint authentication, or retinal authentication may be employed, and any authentication key may be used as long as it can unlock the locking device 22.

The devices 24 to 27 are so-called Internet of Things (IoT) devices, and by being connected to the Internet 5, various information can be transmitted to each other with external devices including the management server 1, and the management server 1 and the security system 6 can appropriately control operation of the devices 24 to 27, and the devices 24 to 27 can transmit appropriate information to the management server 1 and the security system 6. The device 24 is a robot vacuum cleaner that cleans a floor of the room 20 as a maintenance device. The device 25 is an air conditioning device that ventilates and air-conditions the room 20 as a maintenance device. The device 26 is a deodorizing device that deodorizes the room 20 as a maintenance device. The device 27 is an infrared sensor that detects the presence or absence of a moving body inside the room 20 as a detection unit. Further, in the room 20, in addition to the devices 24 to 27, various devices may be provided such as a video camera for photographing an inside of the room 20 and recording an image, or communication device for mutually transmitting information between the user and the management server 1.

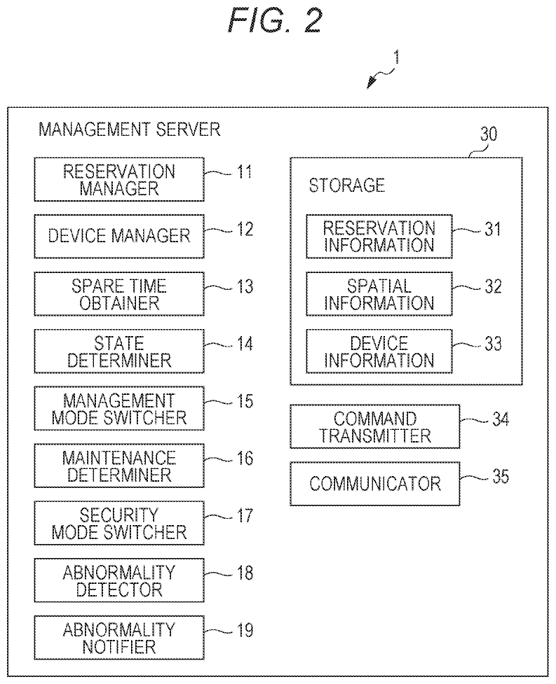

FIG. 2 is a block diagram illustrating a configuration of a management server in the rental space.

The management server 1 includes a server device, and includes: a reservation manager 11 that manages reservation information 31 reserved by the user via the reservation site 4, a device manager 12 that manages device information 33 on the devices 24 to 27 and sets a command to the devices 24 to 27, and a spare time obtainer 13 that obtains spare time of the room 20 on the basis of the reservation information 31. Further, the management server 1 includes a state determiner 14 that determines whether the room 20 is in spare time and is in a non-use state with no moving body in the room 20 on the basis of a detection result of the device 27 and an obtained result of the spare time obtainer 13, and a management mode switcher 15 that switches a management mode from a normal mode to a maintenance mode in which the devices 24 to 26 perform maintenance of the room 20, when the state determiner 14 determines that the room 20 is in the non-use state. Furthermore, the management server 1 includes a maintenance determiner 16 that determines whether the maintenance can be performed on the basis of the spare time obtained by the spare time obtainer 13 and a time required to perform maintenance by the devices 24 to 27, when the management mode is switched to the maintenance mode by the management mode switcher 15.

Further, the management server 1 include a security mode switcher 17 that switches a security mode from a normal mode to a secure mode for guarding the room 20 when the state determiner 14 determines that the room 20 is in the non-use state. Further, the management server 1 includes: an abnormality detector 18 that detects an abnormality in the room 20 on the basis of the detection result of the device 27, in the secure mode; and an abnormality notifier 19 that notifies an administrator of the rental space of the abnormality in the room 20 when the abnormality detector 18 detects the abnormality in the room 20. Furthermore, the management server 1 includes: a storage 30 that stores information such as various programs, the reservation information 31, spatial information 32 that is information on the room 20, and the device information 33 on the devices 24 to 27; a command transmitter 34 that transmits the command to ancillary devices 24 to 27 and the security system 6 via the Internet 5; and a communicator 35 that controls communication with the devices 24 to 27 and the reservation site 4. Note that in the secure mode, the command transmitter 34 may transmit a command for guarding the room 20 via the Internet 5 to the external security system 6, and when using the external security system 6 in this way, the abnormality detector 18 and the abnormality notifier 19 of the management server 1 may be omitted.

The reservation manager 11, the device manager 12, the spare time obtainer 13, the state determiner 14, the management mode switcher 15, the maintenance determiner 16, the security mode switcher 17, the abnormality detector 18, the abnormality notifier 19, the command transmitter 34, and the communicator 35, which are described above, may be executed as a program by a controller including a central processing unit (CPU) and the like provided in the server device, may be configured by independent devices, or may be configured to use cloud computing. Further, the storage 30 may be configured by a storage device such as a hard disk drive (HDD) or a network attached storage (NAS), or may use a storage unit of a cloud service.

When the devices 24 to 27 receive the command from the command transmitter 34 of the management server 1, they perform a predetermined operation on the basis of the received command and transmit their own operation state to the management server 1. That is, when the device 24, which is the robot vacuum cleaner, receives the command from the command transmitter 34 in the maintenance mode, it cleans a floor surface of the room 20 on the basis of a preset operation procedure, and when cleaning is completed, it transmits a completion notification to the management server 1. When the device 25, which is the air conditioning device, and the device 26, which is the deodorizing device, receive the command from the command transmitter 34 in the maintenance mode, they air-condition and deodorize the room 20 on the basis of the preset operation procedure. Further, when the device 27, which is the infrared sensor, receives the command from the command transmitter 34 in the secure mode, it detects the presence or absence of the moving body inside the room 20, and when it detects the moving body, it notifies the management server 1 and the security system 6. Here, the moving body is the user or a moving object moving inside the room 20, a partially movable object, or the like, and the device 27 detects movement of such a moving body. In the management server 1 that has received the detection result, the abnormality detector 18 detects the abnormality in the room 20. Note that the abnormality detector 18 detects the movement of the user or the like out of the moving body as the abnormality in the room 20, but non-detection function is set so as not to detect the operation of the devices 24 to 26 as the abnormality in the room 20. Further, when the moving body does not exist as the maintenance device, the non-detection function can be omitted from the abnormality detector 18.

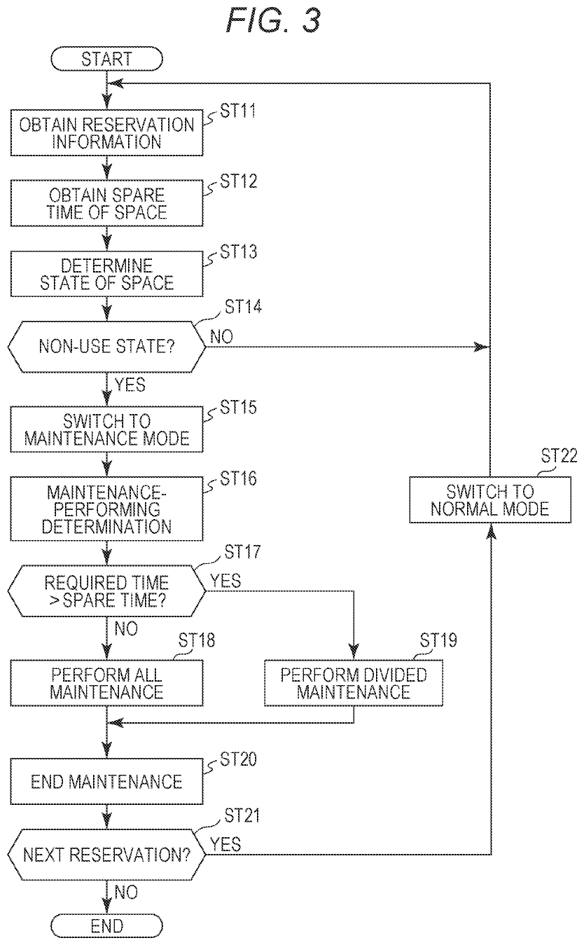

FIG. 3 is a flowchart illustrating an operation of the management mode by the management server.

As illustrated in FIG. 3, in the management mode, the management server 1 obtains the reservation information 31 which the reservation manager 11 has caused the storage unit 30 to store (reservation information obtaining step: Step ST11), and the spare time obtainer 13 obtains the spare time of the room 20 (spare time obtaining step: Step ST12). Subsequently, the management server 1 causes the state determiner 14 to determine whether the room 20 is in spare time and is in the non-use state with no moving body in the room 20 on the basis of the detection result of the device 27 and the obtained result of the spare time obtainer 13 (state determination step: Step ST13). If it is determined in the state determination step (Step ST13) that the room 20 is in the non-use state (YES in Step ST14), the management server 1 switches the management mode of the room 20 from the normal mode to the maintenance mode by the management mode switcher 15 (management mode switching step: Step ST15). On the other hand, if it is determined that the room 20 is not in spare time, or that the moving body is detected in the room 20 and the room 20 is not in the non-use state (NO in Step ST14), the management server 1 keeps the management mode in the normal mode, and returns to the reservation information obtaining step (Step ST11).

In the management mode switching step (Step ST15), after the management mode switcher 15 switches the management mode from the normal mode to the maintenance mode, the management server 1 determines, by the maintenance determiner 16, whether the maintenance can be performed on the basis of the spare time of the room 20 and the time required to perform maintenance by the devices 24 to 26 (maintenance-performing determination step: Step ST16). In the maintenance-performing determination step (Step ST16), the time required for the maintenance of the room 20 by the devices 24 to 26 is calculated on the basis of the spatial information 32 and the device information 33 in the storage 30, and the required time and the spare time are compared (Step ST17). If the required time is less than the spare time (NO in Step ST17), the device manager 12 transmits a maintenance-performing command to the devices 24 to 26 via the command transmitter 34, and causes the devices 24 to 26 to perform all maintenance to (all maintenance-performing step: Step ST18). Here, the all maintenance includes predetermined maintenance operations set for the devices 24 to 26, and means, for example, an operation of causing the device 24, which is the robot vacuum cleaner, to perform cleaning of an entire area of the room 20.

Note that in the present implementations, the time required for the maintenance of the room 20 by the devices 24 to 26 is calculated on the basis of the spatial information 32 and the device information 33 in the storage 30, but as the time required for the maintenance of the room 20 by the devices 24 to 26, a predetermined required time may be stored in the storage 30.

On the other hand, when the required time is longer than the spare time (YES in Step ST17), the device manager 12 does not allow the devices 24 to 26 to perform maintenance, or transmits the maintenance-performing command to the devices 24 to 26 via the command transmitter 34, and causes the devices 24 to 26 to perform divided maintenance (divided maintenance-performing step: Step ST19). Here, the divided maintenance is maintenance that can be performed within the spare time, and is appropriately set depending on the devices 24 to 26, for example, causing the device 24, which is the robot vacuum cleaner, to perform cleaning in a half area of the room 20, or to perform cleaning of a part having a high priority. After performing the all maintenance or the divided maintenance in this way, the management server 1 ends the maintenance by the devices 24 to 26 (maintenance end step: Step ST20), and then determines whether there is a next reservation for the room 20 (Step ST21). Here, the presence or absence of the reservation of the room 20 is only required to be obtained from the reservation information 31 by the reservation manager 11 in the reservation information obtaining step (Step ST11). If there is a next reservation for the room 20 (YES in Step ST21), the management server 1 switches the management mode to the normal mode (Step ST22), and returns to the reservation information obtaining step (Step ST11). If there is no next reservation for the room 20 (NO in Step ST21), the management server 1 ends a process of the management mode.

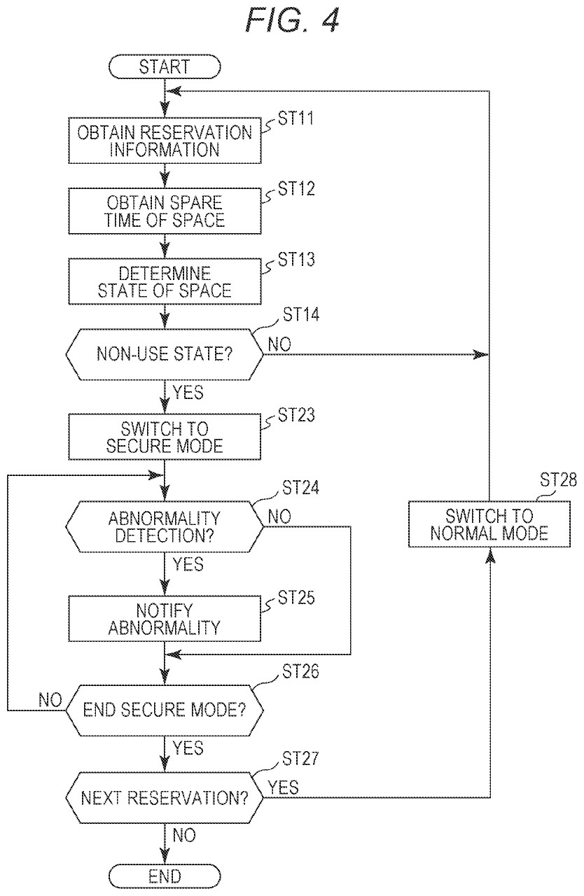

FIG. 4 is a flowchart illustrating an operation of the security mode by the management server.

As illustrated in FIG. 4, in the security mode, the management server 1 obtains the reservation information 31, which the reservation manager 11 has caused the storage unit 30 to store, as in the management mode (reservation information obtaining step: Step ST11), and the spare time obtainer 13 obtains the spare time of the room 20 (spare time obtaining step: Step ST12). Subsequently, the management server 1 causes the state determiner 14 to determine whether the room 20 is in spare time and is in the non-use state with no moving body in the room 20 on the basis of the detection result of the device 27 and the obtained result of the spare time obtainer 13 (state determination step: Step ST13). If it is determined in the state determination step (Step ST13) that the room 20 is in the non-use state (YES in Step ST14), the management server 1 switches the security mode of the room 20 from the normal mode to the secure mode by the security mode switcher 17 (security mode switching step: Step ST23). On the other hand, if it is determined that the room 20 is not in spare time, or that the moving body is detected in the room 20 and the room 20 is not in the non-use state (NO in Step ST14), the management server 1 keeps the security mode in the normal mode, and returns to the reservation information obtaining step (Step ST11).

In the security mode switching step (Step ST23), after the security mode switcher 17 switches the security mode from the normal mode to the secure mode, the management server 1 obtains detection information of the device 27 by the abnormality detector 18, and detects the abnormality in the room 20 (Step ST24). When the abnormality in the room 20 is detected (YES in Step ST24), the abnormality notifier 19 notifies the administrator of the rental space of the abnormality in the room 20 (abnormality notification step: Step ST25). When the abnormality in the room 20 is not detected in Step ST24, and after the abnormality notification step (Step ST25), the management server 1 determines whether to end the secure mode (Step ST26), and when continuing the secure mode (NO in Step ST26), it returns to Step ST24 and detects the abnormality in the room 20. When ending the secure mode (YES in Step ST26), the management server 1 determines whether there is a next reservation for the room 20 (Step ST27). If there is a next reservation for the room 20 (YES in Step ST27), the management server 1 switches the security mode to the normal mode (Step ST28), and returns to the reservation information obtaining step (Step ST11). If there is no next reservation for the room 20 (NO in Step ST27), the management server 1 ends a process of the security mode.

According to the present implementations as described above, the following operations and effects can be obtained.

(1) The management server 1 includes the spare time obtainer 13 that obtains the spare time of the room 20, the state determiner 14 that determine whether the room 20 is in the non-use state with no moving body in the room 20, and the management mode switcher 15 that switches the management mode from the normal mode to the maintenance mode, so that the maintenance of the room 20 can be performed before the reservation date and time of the next user, in the rental space. Therefore, since the devices 24 to 26 can be made to perform maintenance by efficiently utilizing the spare time of the room 20, it is possible to reduce manual management by the administrator or the like, thereby suppressing the operation costs of the rental space.

(2) The management server 1 includes the maintenance determiner 16 that determines whether the maintenance can be performed on the basis of the spare time of the room 20 and the time required to perform maintenance by the devices 24 to 26, when the management mode is switched to the maintenance mode, and when the maintenance determiner 16 determines that the maintenance can be performed, the management server 1 causes the devices 24 to 26 to perform maintenance, so that the maintenance can be completed in the rental space before the reservation date and time of the next user.

(3) The management server 1 includes the security mode switcher 17 that switches the security mode from the normal mode to the secure mode when the state determiner 14 determines that the room 20 is in the non-use state, so that the room 20 can be guarded in the spare time of the room 20 and before the reservation date and time of the next user, in the rental space.

(4) The management server 1 includes the abnormality notifier 19 that notifies the administrator of the rental space of the abnormality in the room 20 when the abnormality detector 18 detects the abnormality in the room 20 in the secure mode, so that the administrator of the rental space can recognize the abnormality in the room 20.

(5) The abnormality detector 18 does not detect the operation of the devices 24 to 26 as the abnormality in the room 20, so that the management server 1 can cause the devices 24 to 26 to perform maintenance even in the secure mode.

(6) The management server 1 includes the command transmitter 34 that transmits the command for guarding the room 20 to the external security system 6 via the Internet 5 in the secure mode, so that the rental space does not have to include a device for guarding the room 20, and it is possible to simplify a configuration of the rental space, thereby further suppressing the operation costs.

### Alternative Implementations

Note that the present disclosure is not limited to the above implementations, and modifications, improvements, and the like within the range in which the object of the present disclosure can be achieved are included in the present disclosure.

For example, in the above implementations, a case where the room 20 of building 2 is rented as the rental room is exemplified, but the rental room is not limited to the conference room, the training room, and the like, and may be a karaoke room, a rental office, a reading space, or the like. Further, in the above implementations, as the maintenance devices, the device 24 which is the robot vacuum cleaner, the device 25 which is the air conditioning device, and the device 26 which is the deodorizing device are exemplified, but the maintenance devices are not limited to the devices 24 to 26, and may be a device that performs other maintenance. Furthermore, in the above implementations, the device 27 which is the infrared sensor is exemplified as the detection unit, but the detection unit is not limited to the infrared sensor, and any device or the like can be used as long as it can detect the moving body in the space.

In the above implementations, a case is exemplified where the management server 1 includes the server device, which is connected to the devices 24 to 27 and the reservation site 4, via the Internet 5 which is the communication line, but the management server is not limited to those including such a centralized management type server device. That is, the management server may be a distributed management type server, for example, a device using a distributed transaction ledger typified by blockchain can be used, and any server can be used as long as it can manage the reservation information, and can manage the management mode and the security mode of the space. Further, in the above implementations, the management server 1 and the reservation site 4 are separately provided and connected to each other via the Internet 5, but the present disclosure is not limited to this, and the management server 1 and the reservation site 4 may be provided in a single site, or the function of the management server and the function of the reservation site may be implemented by a plurality of devices distributed on the Internet.

In the above implementations, the management server 1 includes the maintenance determiner 16 that determines whether the maintenance can be performed on the basis of the spare time of the room 20 and the time required to perform maintenance by the devices 24 to 26, in the maintenance mode, but the maintenance determiner 16 can be omitted. Further, determination as to whether the maintenance can be performed is not limited to a comparison between the spare time of the room 20 and the time required to perform maintenance by the devices 24 to 26, and it may be determined whether the maintenance can be performed based on other conditions.

In the above implementations, the operation of switching the management mode between the normal mode and the maintenance mode by the management mode switcher 15 as illustrated in the flowchart of FIG. 3, and the operation of switching the security mode between the normal mode and the secure mode by the security mode switcher 17 as illustrated in the flowchart of FIG. 4, are described individually, but these operations may be performed at the same time. Further, the operation of the management server 1 is only required to include the management mode that can be switched by the management mode switcher 15, and the security mode may be omitted. Further, in the above implementations, when the abnormality detector 18 detects the abnormality in the room 20 in the secure mode, the abnormality notifier 19 notifies the administrator of the rental space of the abnormality, but the abnormality detector 18 and the abnormality notifier 19 may be omitted. Even when the abnormality detector 18 and the abnormality notifier 19 are omitted, the room 20 can be guarded by transmitting the command from the command transmitter 34 to the external security system 6.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

As used herein: the singular forms “a”, “an,” and “the” include the plural forms as well, unless the context clearly indicates otherwise; the term “and/or” encompasses all possible combinations of one or more of the associated listed items; the terms “first,” “second,” etc. are only used to distinguish one element from another and do not limit the elements themselves; the term “if” may be construed to mean “when,” “upon,” “in response to,” or “in accordance with,” depending on the context; and the terms “include,” “including,” “comprise,” and “comprising” specify particular features or operations but do not preclude additional features or operations.

1. A rental space in which a usage time is set and a space is rented to a user, comprising:
a management server that manages the rental space;
a maintenance device that performs maintenance of the space; and
a detection means that detects the presence or absence of a moving body in the space, wherein
the management server comprises:
a reservation manager that manages reservation information on a reservation date and time of the user who use the space;
a device manager that manages information on the maintenance device and the detection means;
a spare time obtainer that obtains spare time of the space on the basis of the reservation information;
a state determiner that determines whether the space is in spare time and is in a non-use state with no moving body in the space on the basis of a detection result of the detection means and an obtained result of the spare time obtainer; and
a management mode switcher that switches a management mode from a normal mode to a maintenance mode in which the maintenance device performs maintenance of the space, when the state determiner determines that the space is in the non-use state.

2. The rental space according to claim 1, wherein
the device manager manages a time required to perform maintenance by the maintenance device,
the management server includes a maintenance determiner that determines whether the maintenance can be performed on the basis of the spare time obtained by the spare time obtainer and the time required to perform maintenance by the maintenance device, when the management mode switcher switches the management mode to the maintenance mode, and
when the maintenance determiner determines that the maintenance can be performed, the device manager causes the maintenance device to perform maintenance.

3. The rental space according to claim 1, wherein the management server comprises a security mode switcher that switches a security mode from a normal mode to a secure mode for guarding the space, when the state determiner determines that the space is in the non-use state.

4. The rental space according to claim 3, wherein
the management server comprises:
an abnormality detector that detects an abnormality in the space on the basis of the detection result of the detection means, in the secure mode; and
an abnormality notifier that notifies an administrator of the rental space of the abnormality in the space when the abnormality detector detects the abnormality in the space.

5. The rental space according to claim 4, wherein
the abnormality detector does not detect an operation of the maintenance device as the abnormality in the space.

6. The rental space according to claim 3, wherein
the management server comprises a command transmitter that transmits a command for guarding the space to an external security system via a communication line, in the secure mode.
